(19) United States
(12) Patent Application Publication
(10) Pub. No.: US 2008/0103011 A1
(43) Pub. Date: May 1, 2008

(54) Steer Drive for Tracked Vehicles

(75) Inventors: Keith E. Gleasman, Fairport, NY (US); James Y. Gleasman, Rochester, NY (US); Donald Gabel, Rochester, NY (US); Matthew R. Wrona, Fairport, NY (US)

Correspondence Address: MORTON A. POLSTER;BROWN & MICHAELS, P.C., 400 M & T BANK BUILDING, 118 N. TIOGA STREET, ITHACA, NY, 14850, US

(73) Assignee: TORVEC, INC., Pittsford, NY (US)

(21) Appl. No.: 11/553,592

(22) Filed: Oct. 27, 2006

(51) Int. Cl. F16H 48/06

(52) U.S. Cl. 475/248

(57) ABSTRACT

The differential steering drive for a vehicle includes a drive differential and a steering differential. The vehicle includes respective left and right driving traction elements, a propulsion engine with an engine crankshaft, and a steering wheel rotatable by an operator to indicate an intended direction of travel. At least one of the drive differential and the steering differential includes an all-gear limited slip differential. In another embodiment, both the drive differential and the steering differential include an all-gear limited slip differential.

### BACKGROUND OF THE INVENTION

1. Field of the Invention

The invention pertains to the field of tracked vehicles. More particularly, the invention pertains to a steer drive with a differential for improved performance of a tracked vehicle under extreme low traction conditions.

2. Description of Related Art

Differential steering systems for tracked vehicles are well known. Such prior art track steering systems are often identified by such terms as “double differentials”, “steer drives”, and “cross-drive transmissions”, and these prior art steering systems are equally applicable to multi-wheeled off-road vehicles having no angularly adjustable turning axle. Of this prior art, the Gleasman steer drive disclosed in U.S. Pat. No. 4,776,235 has proven to be relatively inexpensive and remarkably effective in testing conducted on a full-terrain tracked vehicle(“FTV®”) built by Torvec, Inc. Using the Gleasman steer drive, the operator readily steers the FTV vehicle with a conventional steering wheel, as contrasted to the more conventional bulldozer-type drives with separate left and right control levers for each track, when traversing paved highways at highway speeds as well as when traversing off-road terrain.

Teachings of the prior art indicate that only some conventional form of unlimited slip differential gearing may be used between the vehicle's engine and the track drives so as not to impair differential rotation of the drive axle shafts. All prior art differential steering drives for tracked vehicles use some conventional form of unlimited slip differential gearing between the vehicle's engine and the track drives. According to the prior art as explained in U.S. Pat. No. 4,776,235, the differentials are understood necessarily to be unlimited slip differentials, so as not to impair differential rotation of the drive axle shafts. Apparently, persons skilled in the art have believed that such a drive differential must be a differential lacking any limited slip devices.

During extensive testing, a problem has been noticed when the FTV tracked vehicle is being turned on terrain that includes portions having unusually low traction. For instance, where one track of the vehicle is traversing extremely soft mud, that track can occasionally lose all traction and begin to “slip”. This is similar to the undesirable slipping that occurs in a truck with a conventional unlimited slip differential, where one set of drive wheels begins to slip on mud, ice, or snow. When the FTV vehicle is turning and the entire track on one side of the vehicle loses traction, the turn is interrupted. In other types of differential drives if the track continues to slip when turning, the drive torque of the vehicle can be completely lost.

As explained in U.S. Pat. No. 4,776,235, the Gleasman steer drive is “no-slip” so long as the tracked vehicle is moving straight ahead or straight back and the steering wheel is held still by the operator. This no-slip condition results from the fact that the drives of both tracks are locked together when the steering worm/worm-wheel combination of the vehicle's steer drive is held motionless. Under this condition, the track drive shafts operate as if they were on straight axles without any separating differential. Nonetheless, when the steering motor drive of this prior art steer drive superimposes different track speeds for turning, the steering worm/worm-wheel combination begins to rotate, and this locked condition is lost. That is, the steer drive introduces differential action between the tracks, and when the drive shafts are differentiating, the loss of drive torque, i.e., slipping, may occur as it does in all conventional unlimited slip differentials when one drive axle loses traction.

The sharpest turn that a conventional bulldozer-type drive, with separate left and right control levers for each track, can make is by braking one track while driving the other track, and this stresses the braked track considerably. Pivot turns using the Gleasman steer drive involve changing the direction of the vehicle with little or no translational movement of the pivot point at the center of the vehicle. Pivot turns can be power assisted or powered totally by driving torque to be executed more rapidly. Since a vehicle is not using driving torque for forward or rearward movement when pivot turning occurs, driving torque is available for powering pivot turns. A slippage, similar to the turn slippage described previously, occurs during pivot turning, when one of the tracks is mired in a low-traction medium.

The interruption of steering or the loss of drive torque when one track slips, is endemic in all differential track drives and has apparently occurred in steer-driven tracked vehicles since their inception. As indicated in documentary information provided on television for the public with the consent of the United States government, this same slipping condition occurs with steer driven U.S. Army Abrams tanks. Abrams tanks also include a steering-wheel type drive in contrast to the more conventional bulldozer-type drives with separate left and right control levers for each track. While this condition is not sufficient to detract from the many advantages of tracked vehicles, it certainly has been a problem that has been plaguing tracked vehicles for a long time, and it occurs often enough in severe off-road terrain to justify correction. Avoidance of such undesirable steering problems is of particular importance for those few tracked vehicles that are capable of traveling at highway speeds.

There is a need in the art for a steer drive that prevents slippage when torque is suddenly reduced and that facilitates pivot turning for the tracked vehicle under extreme low traction conditions.

### SUMMARY OF THE INVENTION

The differential steering drive for a vehicle includes a drive differential and a steering differential. The vehicle includes respective left and right driving traction elements, a propulsion engine with an engine crankshaft, and a steering wheel rotatable by an operator to indicate an intended direction of travel.

The drive differential interconnects the engine crankshaft and a pair of respective drive shafts for differentially driving the respective left and right driving traction elements. The steering differential operatively interconnects the steering wheel and the respective track drive shafts so that rotation of the steering wheel in a first direction causes rotation of the steering differential in a first direction and rotation of the steering wheel in the opposite direction causes rotation of the steering differential in an opposite direction. The speed of rotation of the steering differential in each direction is proportional to the angular rotation of the steering wheel. The rotation of the steering differential in a first direction results in the rotation of the respective track drive shafts in opposite directions. At least one of the drive and steering differentials includes an all-gear limited slip differential.

In a preferred embodiment for high speed tracked vehicles, the drive differential is an all-gear no-clutch type limited slip differential, and the second differential is an unlimited slip differential. The two differentials are arranged to provide no-slip track operation traveling in straight paths or when steering under all conditions so long as at least one track has traction. In a second embodiment, the drive differential is an unlimited slip differential, and the second differential is an all-gear no-clutch type limited slip differential. This latter embodiment is preferred for pivot turning heavier off-road vehicles. In a third embodiment, the drive differential includes an all-gear limited slip differential and the steering differential includes an all-gear limited slip differential.

The all-gear limited slip differential used in all embodiments preferably includes a gear complex having a pair of side-gear worms and at least two sets of paired combination gears. Each side-gear worm is mounted for rotation about an output axis and fixed to a respective output axle. Each combination gear has an axis of rotation that is substantially perpendicular to the output axis. Each combination gear also has a first gear portion spaced apart from a worm-wheel portion. The first gear portions of the combination gear pair are in mating engagement with each other, and the worm-wheel portions of the combination gear pair are in mating engagement, respectively, with a respective one of the side-gear worms. The all-gear limited slip differential may include a thrust plate maintained in a fixed position between the inner ends of the pair of side-gear worms.

### BRIEF DESCRIPTION OF THE DRAWINGS

FIG. 1 shows a partially cross-sectioned side view of a first full-traction differential for use in the present invention.

FIG. 2A shows a schematic cross section of a second full-traction differential for use in the present invention including a complete worm/worm-wheel gear complex incorporated within a one-piece housing.

FIG. 2B shows the embodiment of FIG. 2A as viewed along line 5B-5B.

FIG. 3 shows a schematic view of a preferred embodiment of a steer drive of the present invention.

FIG. 4 shows a schematic view of a steer drive for a multi-axle vehicle in an embodiment of the present invention.

FIG. 5 shows a schematic view of a vehicle pivot turn made possible by the present invention.

FIG. 6 shows a schematic view of a clutch system for a power take-off applying torque to the steering control input for powering pivot turns.

### DETAILED DESCRIPTION OF THE INVENTION

The present invention is related to the subject matter of U.S. Pat. No. 3,735,647, “SYNCLINAL GEARING”, issued to Gleasman on May 29, 1973, U.S. Pat. No. 4,776,235, “NO-SLIP, IMPOSED DIFFERENTIAL REDUCTION DRIVE”, issued to Gleasman et al. on Oct. 11, 1988, and U.S. Pat. No. 6,783,476, “COMPACT FULL-TRACTION DIFFERENTIAL”, issued to Gleasman et al. on Aug. 31, 2004, all of which are hereby incorporated by reference herein.

Teachings of the prior art steer-drives indicate that only some conventional form of unlimited slip differential gearing may be used between the vehicle's engine and the track drives so as not to impair differential rotation of the drive axle shafts. However, undesirable slipping can occur in a tracked vehicle when the vehicle is being steered, because the steering drive motor is moving the otherwise locked-up drive of the steering differential and, thus, both differentials are differentiating. Under this condition, should one of the tracks suddenly lose traction, the torque load becomes significantly out of balance, allowing the slipping track to increase in speed and reducing the speed and drive torque on the other track in relation to the increased speed of the slipping track.

At least one of the differentials of the present invention is an all-gear limited slip type of differential as opposed to the conventional unlimited slip differentials taught in the prior art. A limited slip differential allows for a difference in rotational velocities of the differentiating output shafts but does not allow the difference to increase beyond a set amount. Some all-gear differentials cause the gears to bind together or against the housing to provide a torque bias when traction is lost. However, the preferred all-gear limited slip differentials of the invention use the mechanical advantage of the worm-like design of the side gears operating against the worm-wheel design of the combination gears to allow normal differential action around a turn and, should the traction under one drive component become significantly less than the traction under the other drive component, this same mechanical advantage prevents the transfer of excess torque to the drive component with less traction. Increasingly greater torque is transferred to the traction component having greater traction until the difference in the torque being transferred to each drive component reaches a predetermined torque bias ratio. The gear design determines the torque bias ratio, which is the ratio of torque applied to the traction component with better traction to the torque applied to the component having lesser traction.

In a first embodiment, the drive differential is an all-gear limited slip type differential, and the steering differential is a conventional unlimited slip differential. In a second embodiment, the drive differential is a conventional unlimited slip differential, and the steering differential is an all-gear limited slip type differential. In a third embodiment, the drive differential and the steering differential are both all-gear limited slip type differentials.

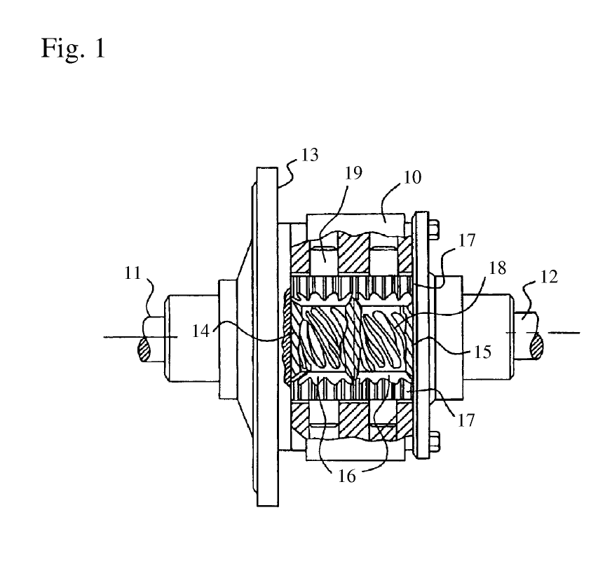

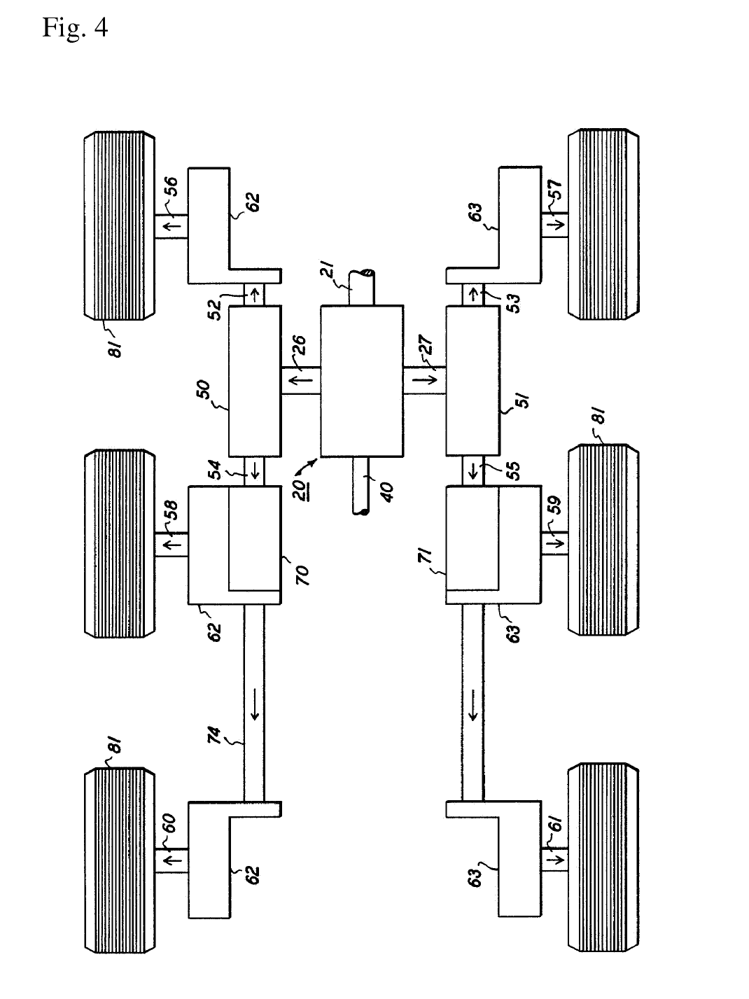

Using an all-gear limited slip type of differential as the drive differential of the steer drive prevents the above-described condition that occurs when traction is suddenly reduced under one drive member. While any all-gear limited slip differential may be used in any steer drive of the present invention, the all-gear differentials discussed herein are preferred, namely, the older design shown in FIG. 1 that is widely used under the trademark Torsen® or the more compact design shown in FIGS. 4, 5A and 5B and identified commercially by the trademark IsoTorque®. As just stated above, avoidance of such undesirable steering problems is of particular importance for those few tracked vehicles that are capable of traveling at highway speeds. This important revision, however, does not otherwise affect the operation of the basic features of the original steer-drive, which continues to function in the same manner. Namely, when the vehicle is being driven in a straight direction, the differentials still both act as straight axles, and when the vehicle operator indicates a change in direction by turning the vehicle's steering wheel, the steering motor still turns the housing of the steering differential either forward or in reverse, and the speeds of the tracks are respectively increased and decreased to accomplish the change of direction as explained in U.S. Pat. No. 4,776,235.

With the present invention's use of the limited slip differential, pivot turns still change the direction of the vehicle with little or no translational movement of the pivot point at the center of the vehicle. Pivot turns are still preferably powered totally by substantial torque provided by the separate differential steering system motor, since the torque of that steering motor is still greatly increased by a worm/wormgear ratio (preferably ≧15:1).

During such pivot turning with prior art steering systems, the vehicle operator generally applies a brake to, or otherwise holds, the engine crankshaft in a locked condition. However, when pivot turning with heavy, relatively slow-moving off-road vehicles, conditions arise such that it is not desirable to lock the engine crankshaft. In these latter instances, should the traction load being shared between the tracks become significantly unbalanced, the pivoting motion may be completely stopped. This pivot turning problem is avoided in the present invention by replacing the traditional steering differential with an all-gear limited slip type of differential that does not slip when such torque imbalance occurs.

### Limited-Slip Differential

As shown in FIG. 1, a first embodiment of a limited-slip differential for use in the present invention includes a rotatable gear housing 10 and a pair of drive axles 11, 12 received in bores formed in the sides of housing 10. This type of differential, as disclosed in U.S. Pat. No. 3,735,647, has enjoyed fairly widespread use and publicity throughout the world under the trademark Torsen. This limited-slip differential, which is an all-gear differential, includes no slipping plates or other form of clutch apparatus and uses either a crossed-axis or a parallel axis arrangement in a “compound planetary gear complex” format. While either of these formats may be used, the crossed-axis prior-art differential format is preferred, and only this format is explained with greater particularity in the following discussion.

A flange 13 is preferably formed at one end of housing 10 for mounting a ring gear (not shown) for providing rotational power from an external power source, typically from a vehicle's engine. The gear arrangement within housing 10 is often called a “crossed-axis compound planetary gear complex” and preferably includes a pair of side-gear worms 14, 15 fixed, respectively, to the inner ends of axles 11, 12 and several sets of combination gears 16 organized in pairs. Each combination gear preferably has outer ends formed with integral spur gear portions 17 spaced apart from a “worm-wheel” portion 18. While standard gear nomenclature uses the term “wormgear” to describe the mate to a “worm”, this often becomes confusing when describing the various gearing of an all-gear differential. Therefore, as used herein, the mate to a worm is called a “worm-wheel”.

Each pair of combination gears 16 is preferably mounted within slots or bores formed in the main body of housing 10 so that each combination gear rotates on an axis that is substantially perpendicular to the axis of rotation of side-gear worms 14, 15. In order to facilitate assembly, each combination gear 16 preferably has a full-length axial hole through which is received a respective mounting shaft 19 for rotational support within journals formed in housing 10.

Combination gears are known with integral hubs that are received into the journals of housing 10, but to facilitate design of the housing and assembly, the combination gears of most presently used limited-slip differentials of this type are shaft-mounted. The spur gear portions 17 of the combination gears 16 of each pair are in mesh with each other, while the worm-wheel portions 18 are, respectively, in mesh with one of the side-gear worms 14, 15 for transferring and dividing torque between axle ends 11, 12. In order to carry most automotive loads, prior art differentials of this type usually include three sets of paired combination gears positioned at approximately 120° intervals about the periphery of each side-gear worm 14, 15.

This type of differential does a remarkable job of preventing undesirable wheel slip under most conditions. In fact, one or more of these limited-slip differentials are either standard or optional on vehicles presently being sold by at least eight major automobile companies throughout the world, and there are two Torsen limited-slip differentials in every U.S. Army HMMWV (“Hummer”) vehicle, one differentiating between the front wheels and the other between the rear wheels.

A salient feature of the crossed-axis gear complex of high-traction differentials is the mechanical advantage resulting from the worm/worm-wheel combination in the gear train between the vehicle's wheels and the differential. As a vehicle travels around curves, the weight and inertia of the vehicle cause the wheels to roll simultaneously over the surface of the road at varying speeds, resulting in the need for differentiation. The initiation of such differentiation is greatly enhanced by a mechanical advantage between the side-gear worms and their mating worm-wheels. Of course, this same gearing results in mechanical disadvantage when torque is being transferred in the opposite direction. The preferred embodiments of the IsoTorque differential select 35°/55° for the worm/worm-wheel teeth to provide both full traction as well as relative ease of differentiation, a selection that also makes the differential particularly appropriate for vehicles including automatic braking systems (ABS) having traction controls.

A further feature of the IsoTorque differential provides torque balancing that equalizes the end thrust on the respective side-gear worms during vehicle turning, when being driven in either forward or reverse, regardless of the direction of travel. A thrust plate is supported by the same mounting that supports the sets of paired combination gears, being fixed against lateral movement and maintained between the inner ends of the side-gear worms. Thus, when under thrust to the left, the right worm exerts a thrust force X against the thrust plate, and the left worm exerts only its own thrust force X against the housing rather than the 2X force as in previous differentials. Similarly, when under thrust to the right, the left worm exerts a thrust force X against the thrust plate, and the right worm exerts only its own thrust force X against the housing.

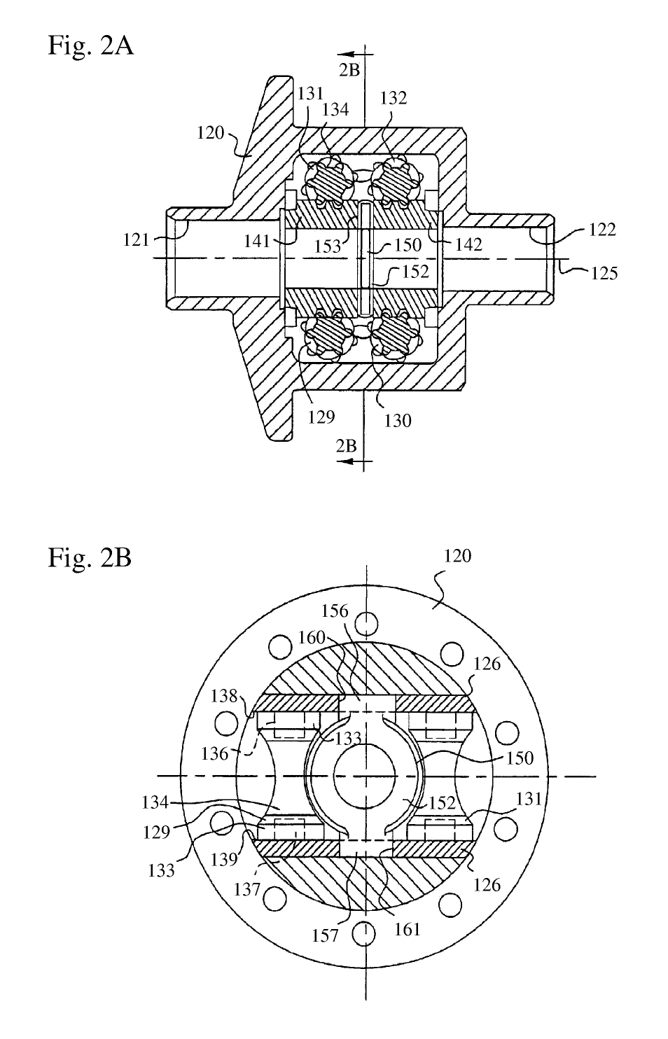

Referring to FIG. 2A and FIG. 2B, another feature of the differential is shown in an embodiment to overcome the torque imbalance of previous high-traction differentials that results from the transfer of end thrust between the side-gear worms. The differential incorporates a complete worm/worm-wheel gear complex. The housing 120 is formed, preferably, in one piece from powder metal and has only three openings. Namely, a first set of appropriate openings 121, 122 is aligned along a first axis 125 for receiving the respective inner ends of output axles (not shown), and only a single further opening 126, which is rectangular in shape and extends directly through housing 120, is centered perpendicular to axis 125.

Two pair of combination gears 131, 132 and 129, 130 each have respective spur gear portions 133 separated by an hourglass-shaped worm-wheel portion 134 that are designed and manufactured as described above. The respective spur gear portions 133 of each pair are in mesh with each other, and all of these combination gears are rotatably supported on sets of paired hubs 136, 137 that are formed integrally with an opposing pair of mounting plates 138, 139. The respective worm-wheel portions 134 of combination gear pair 131, 132 are in mesh with respective ones of a pair of side-gear worms 141, 142, while the respective worm-wheel portions 134 of combination gear pair 129, 130 are similarly in mesh with, respectively, the same pair of side-gear worms 141, 142.

Positioned intermediate the inner ends of side-gear worms 141, 142 is a thrust plate 150. Thrust plate 150 includes respective bearing surfaces 152, 153, mounting tabs 156, 157, and a weight-saving lubrication opening (not shown). Mounting tabs 156, 157 are designed to mate with slots 160, 161 formed centrally in identical mounting plates 138, 139. Slots 160, 161 not only position thrust plate 150 intermediate the inner ends of side-gear worms 141, 142 but also prevent lateral movement of thrust plate 150. Therefore, referring specifically to FIG. 2A, when driving torque applied to side-gear worms 141, 142 results in thrust to the left, worm 142 moves against fixed bearing surface 152 of thrust plate 150, while worm 141 moves away from fixed bearing surface 153 of thrust plate 150 and against housing 120 (or against appropriate washers positioned conventionally between worm 141 and housing 120). The resulting friction against the rotation of worm 141 is unaffected by the thrust forces acting on worm 142.

Similarly, when driving torque applied to side-gear worms 141, 142 results in thrust to the right, worm 141 moves against fixed bearing surface 153 of thrust plate 150, while worm, 142 moves away from fixed bearing surface 152 of thrust plate 150 and against housing 120 (or, again, against appropriate washers positioned conventionally between worm 142 and housing 120). Similarly, the resulting friction against the rotation of worm 142 is unaffected by the thrust forces acting on worm 141. Thus, regardless of the direction of the driving torque, the friction acting against the rotation of each side-gear worm is not affected by the thrust forces acting on the other side-gear worm. Since the torque bias of the differential is affected by frictional forces, this prevention of additive thrust forces helps to minimize torque imbalance, i.e., differences in torque during different directions of vehicle turning.

Other features of an all-gear limited slip differential as known in the art may also be incorporated into a steer drive of the present invention. Such features include, but are not limited to, solid gear bodies with shallow journal holes, deeper hourglass shapes on the solid worm-wheel portions, closed-end teeth on the side-gear worms, and reduced diameter and axial length side-gear worms as disclosed in U.S. Pat. No. 6,783,476. While these size-reducing features are highly advantageous in automobile differentials with limited space and weight, size and weight are much less critical in a steer drive of the present invention and the manufacturing cost to incorporate these features may outweigh any potential advantages.

### Steer Drive Structure

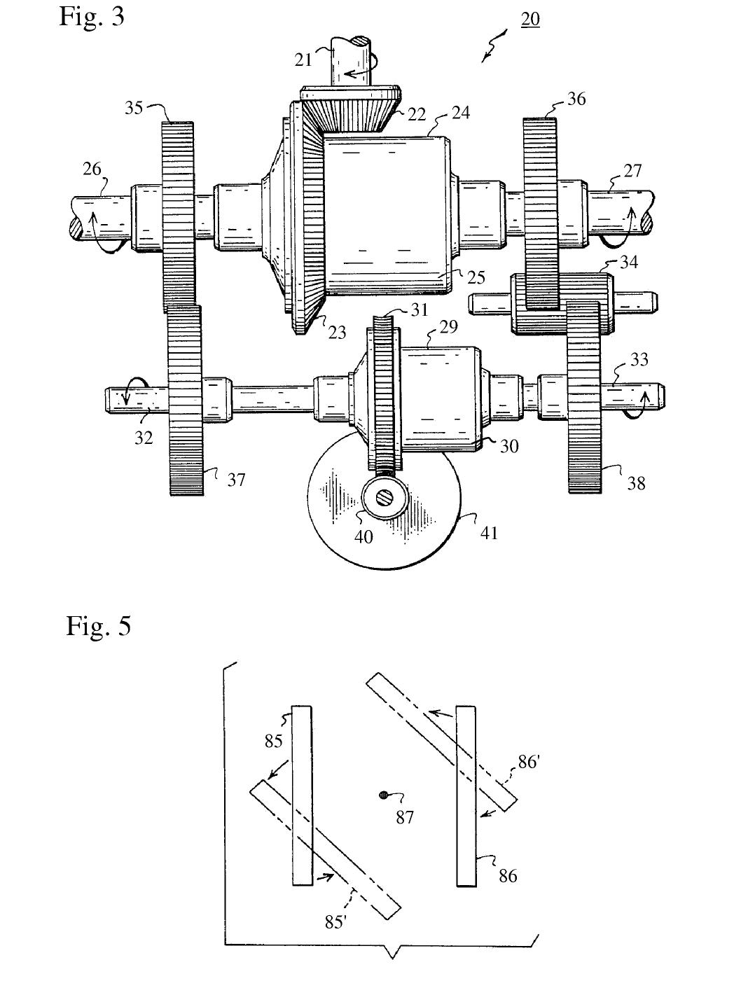

As shown in FIG. 3, when a steer drive of the present invention 20 is applied to a vehicle, engine power input via shaft 21 turning gear 22 rotates ring gear 23 and case 24 of a drive differential 25. Drive differential 25 is connected for driving a pair of respective axle shafts 26 and 27 for differentially driving respective left and right driving traction elements on opposite sides of the vehicle. Drive differential 25 is suitably sized to the vehicle being driven. This can range from small garden tractors and tillers up to large tractors and earth movers.

A steering differential 30 having a case 29 is connected between a pair of steering control shafts 32 and 33 that are interconnected in a driving relationship with axle drive shafts 26 and 27. One steering control shaft 33 and one axle drive shaft 27 are connected for rotation in the same direction, and another steering control shaft 32 and another axle drive shaft 26 are connected for rotation in opposite directions. This causes counter or differential rotation of control shafts 32 and 33 as axle shafts 26 and 27 rotate in the same direction and conversely causes differential rotation of axle shafts 26 and 27 as control shafts 32 and 33 rotate in the same direction.

At least one of the differentials 25, 30 of the present invention is an all-gear limited slip type of differential (e.g., preferably similar to the type disclosed in U.S. Pat. No. 3,735,647 or, more preferably, to the type disclosed in U.S. Pat. No. 6,783,476). This is in opposition to the specific teachings of the prior art that only unlimited slip differentials should be used. In a first embodiment, the drive differential 25 is an all-gear limited slip type differential, and the steering differential 30 is a conventional unlimited slip differential. In a second embodiment, the drive differential 25 is a conventional unlimited slip differential, and the steering differential 30 is an all-gear limited slip type differential. In a third embodiment, the drive differential 25 is an all-gear limited slip type differential, and the steering differential 30 is an all-gear limited slip type differential.

Gear connections between steering control shafts and axle drive shafts as shown in FIG. 3 are preferred for larger and more powerful vehicles. These include axle shaft gears 35 and 36 fixed respectively to axle shafts 26 and 27 and control shaft gears 37 and 38 fixed respectively to control shafts 32 and 33. Meshing axle shaft gear 35 with control shaft gear 37 provides opposite rotation between axle shaft 26 and control shaft 32, and meshing both axle shaft gear 36 and control shaft gear 38 with idler gear 34 provides same direction rotation for axle shaft 27 and control shaft 33.

Gear connections between steering control shafts and axle drive shafts are preferably incorporated into an enlarged housing containing both drive differential 25 and steering differential 30. For a reason explained below, steering differential 30 can be sized to bear half the force borne by drive differential 25 so that the complete assembly can be fitted within a differential housing that is not unduly large.

Smaller or less powerful vehicles can use shaft interconnections such as belts or chains in place of gearing. Also, shaft interconnections need not be limited to the region of the axle differential and can be made toward the outer ends of the axle shafts.

A gear or drive ratio between steering control shafts and axle drive shafts is preferably 1:1. This ratio can vary, however, so long as it is the same on opposite sides of the axle and control differentials.

An input steering gear 40 meshes with a ring gear 31 fixed to casing 29 of steering differential 30 for imposing differential rotation on the system. Gear 40 is preferably a worm, and ring gear 31 is preferably a wormgear so that ring gear 31 turns only when gear 40 turns.

For steering purposes, steering gear 40 can be turned by several mechanisms, depending on the relative loads. Steering mechanisms can use various types of appropriately sized motors for turning gear 40. For instance, a DC starter motor 41 can be electrically energized via a rheostat in the steering system, or a hydraulic or pneumatic motor 41 can be turned by a vehicle's hydraulic or pneumatic system in response to a steering control. Preferably, motor 41 is hydraulic, and the worm 40/wormgear 31 ratio is around 15:1.

As indicated above, slipping occurs with prior art differential steering systems when the vehicle is being steered because the steering drive motor is moving the otherwise locked-up worm/wormgear drive of the steering differential and, thus, both differentials are differentiating. Under this condition, should one of the tracks suddenly lose traction, the torque imbalance allows the slipping track to increase in speed, reducing the drive torque and speed of the other track in direct relation to the increased speed of the slipping track.

When the conventional differential used by prior art differential steering systems for drive differential 25 is replaced, as indicated above in the first embodiment, with an all-gear limited slip differential (e.g., with the Torsen differential described in U.S. Pat. No. 3,735,647 or the IsoTorque differential described in U.S. Pat. No. 6,783,476) that does not slip when torque is suddenly reduced, this undesirable condition is prevented.

However, it is important to note that this revision does not otherwise affect the operation of the basic steer-drive, which continues to function in the same manner. Namely, when the vehicle is being driven in a straight direction, the non-rotation of the steering gear 40/ring gear 31 combination still causes both differentials to act as straight axles, and when the vehicle operator indicates a change in direction by turning the vehicle's steering wheel, the steering motor turns the housing of the differential either forward or in reverse, and the speeds of the tracks are respectively increased and decreased to accomplish the change of direction as explained in U.S. Pat. No. 4,776,235.

However, since the invention's drive differential 25 is an all-gear limited slip differential, whenever the torque load shared by the tracks suddenly begins to become unbalanced, the torque bias of drive differential 25 immediately transfers a substantial portion of the drive torque received from engine input shaft 21 to the track having the better traction (e.g., up to eight times as much torque in a 8:1 differential). Thus, as soon as the traction load on either track results in a significant load imbalance, a sufficient portion of the drive torque is still delivered to the track having better traction to maintain movement of the tracked vehicle.

As indicated above, the preferred embodiments of the invention relate to a multi-axle vehicle is a track-laying vehicle such as the vehicle described in U.S. Pat. No. 6,135,220. Nonetheless, the invention is also effective for use in other multi-axle vehicles. In a further embodiment of the present invention, the steer drive 20 of FIG. 3 is used in a multi-axle vehicle as shown in FIG. 4. A system of axle differentials distributes steer driving torque from output shafts 26 and 27 along respective right and left sides of the vehicle. Axle differentials 50 and 51 divide torque from output shafts 26 and 27 respectively between drive shafts 52 and 54 and drive shafts 53 and 55 extending along respective right and left sides of the vehicle. Although axle differentials 50 and 51 can be conventional bevel gear differentials, these have the disadvantage of directing torque to whichever wheel has the least traction, so axle differentials 50 and 51 are preferably all-gear limited-slip differentials. As with the drive differential 25 and the steering differential 30 in FIG. 3, the preferred all-gear limited slip differentials as axle differentials 50 and 51 use the mechanical advantage of the worm-like design of the side gears operating against the worm-wheel design of the combination gears to allow normal differential action around a turn, and should the traction under one drive component become significantly less than the traction under the other drive component, this same mechanical advantage prevents the transfer of excess torque to the drive component with less traction. Increasingly greater torque is transferred to the traction component having greater traction until the difference in the torque being transferred to each drive component reaches a predetermined torque bias ratio. The gear design determines the torque bias ratio, which is the ratio of torque applied to the traction component with better traction to the torque applied to the component having lesser traction.

A steer drive system of the present invention may apply to any number of drive axles for a vehicle, and FIG. 4 schematically represents a variation having two front drive axles 56 and 57 forward of axle differentials 50 and 51 and four rear drive axles 58, 59, 60, 61 rearward of axle differentials 50 and 51. The two front drive axles 56 and 57 receive torque directly from shafts 52 and 53 via two reduction gears 62 and 63, which are preferred to allow smaller size and higher speed distribution shafts to turn larger size and higher torque axle shafts. Axle differentials 70 and 71 are also preferably all-gear limited-slip differentials, for the same reasons that drive differential 25, steering differential 30, and axle differentials 50, 51 are preferably all-gear limited-slip differentials, as explained previously. For a differential having an inline configuration, such as differential 70, torque from input shaft 54 directly rotates the differential casing within which torque divides between a hollow output shaft (not shown) surrounding a coaxial output shaft 74. The wheels 81 may be used to engage the road or terrain directly or may drive the endless tracks of a tracked vehicle.

### No-Slip, Steer-Drive Operation

Two important effects occur from the interconnection of steering differential 30 and its control shafts 32 and 33 with axle drive differential 25 and axle shafts 26 and 27. One is a no-slip drive that prevents wheels or tracks from slipping unless slippage occurs on both sides of the vehicle at once. The other effect is imposed differential rotation that can accomplish steering to pivot or turn a vehicle.

The no-slip drive occurs because axle drive shafts 26 and 27 are geared together via steering differential 30. Power applied to an axle shaft on a side of the vehicle that has lost traction is transmitted to the connecting control shaft on that side, through differential 30 to the opposite control shaft, and back to the opposite axle shaft where it is added to the side having traction. So if one axle shaft loses traction, the opposite axle shaft drives harder, and the only way slippage can occur is if both axle shafts lose traction simultaneously.

To elaborate on this, consider a vehicle rolling straight ahead with its axle shafts 26 and 27 turning uniformly in the same direction. Steering gear 40 is stationary for straight ahead motion, and since steering gear 40 is preferably a worm, worm-wheel 31 of steering differential 30 cannot turn. Control shafts 32 and 33, by their driving connections with the axle drive shafts, rotate differentially in opposite directions, which steering differential 30 accommodates.

Drive differential 25 equally divides the power input from engine crankshaft 21 and applies half of the input power to each axle shaft 26 and 27. If the track or wheel being driven by axle shaft 26 loses traction, it cannot apply the power available on shaft 26 and tends to slip. Actual slippage cannot occur, however, because axle shaft 26 is geared to control shaft 32. So if a wheel or track without traction cannot apply the power on shaft 26, this is transmitted to control shaft 32, which rotates in an opposite direction from axle shaft 26. Since ring gear 31 cannot turn, rotational power on control shaft 32 is transmitted through differential 30 to produce opposite rotation of control shaft 33. This is geared to axle shaft 27 via idler gear 34 so that power on control shaft 33 is applied to axle shaft 27 to urge shaft 27 in a forward direction, driving the wheel or track that has traction and can accept the available power. Since only half of the full available power can be transmitted from one axle shaft to another via differential 30 and its control shafts, these can be sized to bear half the force borne by axle differential 25 and its axle shafts.

Of course, unusable power available on axle shaft 27, because of a loss of traction on that side of the vehicle, is transmitted through the same control shaft and control differential route to opposite axle shaft 26. This arrangement applies the most power to the wheel or track having the best traction, which is ideal for advancing the vehicle. The wheel or track that has lost traction maintains rolling engagement with the ground while the other wheel or track drives. The only time wheels or tracks can slip is when they both lose traction simultaneously.

To impose differential rotation on axle shafts 26 and 27 for pivoting or turning the vehicle, it is still only necessary to rotate steering gear 40. This differentially rotates axle shafts to turn or pivot the vehicle because of the different distances traveled by the differentially rotating wheels or tracks on opposite sides of the vehicle.

Whenever steering gear 40 turns, it rotates ring gear 31, which turns the casing 29 of steering differential 30 to rotate control shafts 32 and 33 in the same direction. The connection of control shafts 32 and 33 with axle drive shafts 26 and 27 converts the same direction rotation of control shafts 32 and 33 to opposite differential rotation of axle shafts 26 and 27, as accommodated by drive differential 25. This drives wheels or tracks forward on one side of the vehicle and rearward on the other side of the vehicle, depending on the direction of rotation of steering gear 40.

Such differential rotation is added to whatever forward or rearward rotation of the axle shafts is occurring at the time. So if a vehicle is moving forward or backward when steering gear 40 turns, the differential rotation advances and retards opposite axle shafts and makes the vehicle turn.

If a vehicle is not otherwise moving when steering gear 40 turns, the vehicle's left and right driving traction elements (wheels or tracks) go forward on one side and backward on the other side so that the vehicle pivots on a central point. This is schematically illustrated in FIG. 5 for a vehicle having a pair of tracks 85 and 86. Both tracks can have a rolling engagement with the ground as the vehicle rotates around a center point 87 by driving right track 86′ forward and left track 85′ rearward. The tracks experience some heel and toe scuffing, but this causes less stress and disturbance of the terrain than is caused by the traditional locking of one track by a brake while the other track is driven. The pivot turn also spins the vehicle on one point 87, without requiring motion in any direction as must occur when one track is braked and another is driven.

In prior art steer drives, the above-described no-slip drive functions only so long as the vehicle is traveling straight ahead or straight back and steering gear 40 and steering differential 30 are not operating in response to the driver's rotation of the vehicle's steering wheel. However, as explained above, in prior art steer drives, when steering differential 30 is differentiating and one of the tracks completely loses traction, the steer drive introduces differential action between the tracks, and the drive torque of the vehicle can still be completely lost if that track continues to slip. This total loss of driving torque does not occur with the improved steer drive of the invention herein.

Namely, since drive differential 25 is an all-gear limited slip differential, whenever the torque load shared by the tracks suddenly begins to become unbalanced, the torque bias of drive differential 25 immediately transfers a substantial portion of the drive torque received from engine input shaft 21 to the track having the better traction (e.g., this transfer of drive torque occurs up to a torque imbalance of eight times in an 8:1 differential). Thus, as soon as the traction load on either track results in a significant load imbalance, a sufficient portion of the drive torque is still delivered to the track having better traction to maintain movement of the tracked vehicle.

### Improved Pivot Turning

As indicated above, during pivot turning with prior art differential steering systems, the operator of a tracked vehicle generally applies a brake to, or otherwise holds, the engine crankshaft in a locked condition. With heavy, relatively slow-moving off-road vehicles operating in terrain where traction can vary greatly between tracks, conditions arise when pivot turning is desired but the usual locking of the engine crankshaft is not appropriate. As explained above, under such conditions, severe traction imbalance can result in undesirable loss of pivot turn motion.

To facilitate pivot turning for such vehicles, the present invention replaces the traditional steering differential with an all-gear limited slip type of differential (e.g., IsoTorque differential), as described in the second embodiment previously, that does not slip when torque imbalance occurs. This simple change overcomes pivot turn problems under all conditions so long as one track retains traction.

To prevent slip when torque is suddenly reduced and to facilitate pivot turning for the tracked vehicle, in the third embodiment of the present invention, drive differential 25 and steering differential 30 are both replaced with all-gear limited slip type of differentials (e.g., IsoTorque differentials).

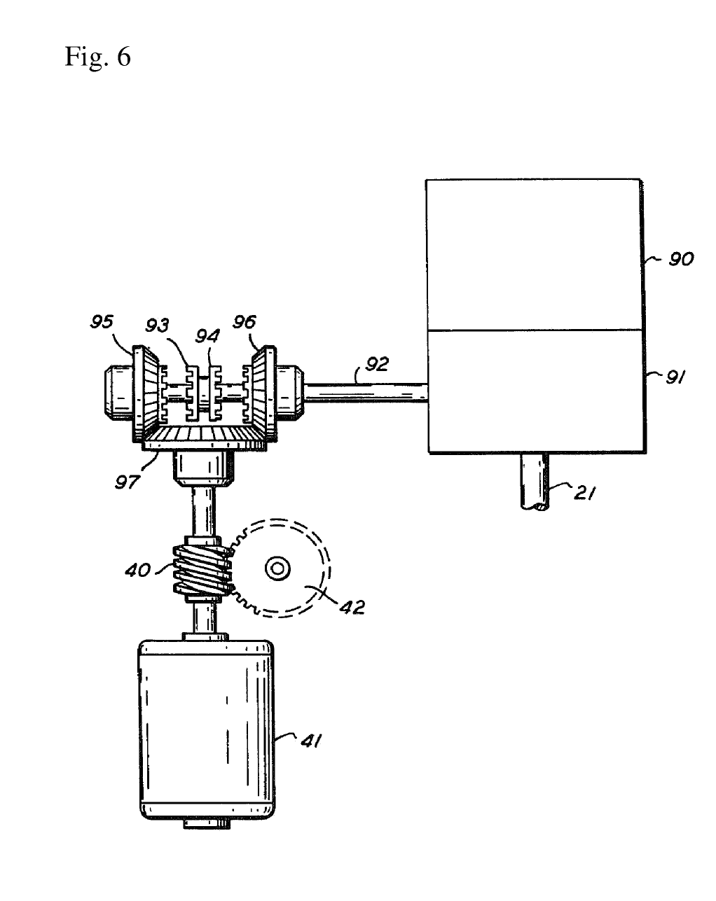

Referring to FIG. 6, power take-off 92 from a transmission 91 or main propulsion engine 90 rotates clutch parts 93 and 94. Either of these can be engaged with its counterpart 95 and 96, respectively, each of which is meshed with bevel gear 97 rotating with worm 40. To apply driving torque to a pivot turn in one direction, clutch part 93 is meshed with clutch part 95 to turn bevel gear 97 in the desired direction for rotating worm 40 and worm-wheel 42. Steering control motor 41 can be unclutched for engine powered pivot turns or can combine its torque with the torque provided via bevel gear 97. For applying propulsion torque to power a pivot turn in an opposite direction, clutch part 94 meshes with its counterpart 96, driving bevel gear 97 in an opposite direction and turning worm 40 and worm-wheel 42 in an opposite direction.

A power take-off can be derived from many points along the main propulsion drive train, including engine 90, transmission 91, and other points. A power take-off can be made to turn continuously or be operated only when needed for pivot turns. The engagement of clutch parts 93 and 94 can be made responsive to full turn of a steering wheel, calling for a pivot turn, and any engagement of clutch parts 93 and 94 can be locked out during forward or rearward movement of the vehicle, if desired. Propulsion assisted pivot turning can also be applied to worm-wheel 42 by a worm separate from steering control input worm 40, and different clutch arrangements can be used for engaging and disengaging the diversion of drive torque for pivot turning. Applying drive torque to the steering control input allows pivot turns to be accomplished more rapidly than would be possible with a small sized steering control motor 41, adequate for forward and rearward steering.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A differential steering-drive for a vehicle having respective left and right driving traction elements, a propulsion engine with an engine crankshaft, and a steering wheel rotatable by an operator to indicate an intended direction of travel, said steering-drive comprising:
a drive differential interconnecting said engine crankshaft and a pair of respective drive shafts for differentially driving said respective left and right driving traction elements; and
a steering differential operatively interconnecting said steering wheel and said respective drive shafts so that rotation of said steering wheel in a first direction causes rotation of said steering differential in a first direction and rotation of said steering wheel in the opposite direction causes rotation of said steering differential in an opposite direction, the speed of rotation of said steering differential in each direction being proportional to the angular rotation of said steering wheel, and so that the rotation of said steering differential in a first direction results in the rotation of said respective drive shafts in opposite directions; and
wherein at least one of said drive and steering differentials comprises an all-gear limited slip differential.

2. The differential steering-drive of claim 1, wherein said drive differential comprises an all-gear limited slip differential.

3. The differential steering-drive of claim 2, wherein said steering differential comprises an all-gear limited slip differential.

4. The differential steering-drive of claim 1, wherein said steering differential comprises an all-gear limited slip differential.

5. The differential steering-drive of claim 1, wherein said all-gear limited slip differential comprises a gear complex comprising:
a pair of side-gear worms, each side-gear worm being mounted for rotation about an output axis and fixed to a respective output axle; and
at least two sets of paired combination gears, each combination gear of each pair having (a) an axis of rotation that is substantially perpendicular to said output axis, and (b) a first gear portion spaced apart from a worm-wheel portion, said first gear portions of said combination gear pair being in mating engagement with each other, and said worm-wheel portions of said combination gear pair being in mating engagement, respectively, with a respective one of said side-gear worms.

6. The differential steering-drive of claim 5, wherein said all-gear limited slip differential further comprises a thrust plate maintained in a fixed position between the inner ends of said pair of side-gear worms.

7. The differential steering-drive of claim 1 further comprising a first pair of axle differentials interconnecting said respective drive shafts with a first pair of front drive shafts and a first pair of rear drive shafts, wherein said first pair of axle differentials comprises a first pair of all-gear limited slip differentials.

8. The differential steering-drive of claim 7 further comprising a second pair of axle differentials interconnecting said respective first pair of rear drive shafts with a second pair of rear drive shafts, wherein said second pair of axle differentials comprises a second pair of all-gear limited slip differentials.

9. A differential steering-drive for a tracked vehicle having a pair of respective driving tracks, a propulsion engine with an engine crankshaft, and a steering wheel rotatable by an operator to indicate an intended direction of travel, said steering-drive comprising:
a drive differential having a first case driven by said engine crankshaft and a pair of respective track drive shafts differentially driven by the rotation of said first case; and
a steering differential having a second case driven by a steering motor through a worm/worm-wheel connection and a pair of respective control shafts differentially driven by the rotation of said second case, said respective control shafts being connected by gearing to said respective track drive shafts so that rotation of said respective track drive shafts in a first direction results in the rotation of said control shafts in opposite directions;
said steering motor being operatively connected with said steering wheel so that rotation of said steering wheel in a first direction causes rotation of said steering motor in a first direction and rotation of said steering wheel in the opposite direction causes rotation of said steering motor in an opposite direction, the speed of rotation of said steering motor in each direction being proportional to the angular rotation of said steering wheel; and
wherein at least one of said drive and steering differentials comprises an all-gear limited slip differential.

10. The differential steering-drive of claim 9, wherein said drive differential comprises an all-gear limited slip differential.

11. The differential steering-drive of claim 10, wherein said steering differential comprises an all-gear limited slip differential.

12. The differential steering-drive of claim 9, wherein said steering differential comprises an all-gear limited slip differential.

13. The differential steering-drive of claim 9, wherein said all-gear limited slip differential comprises a gear complex comprising:
a pair of side-gear worms, each side-gear worm being mounted for rotation about an output axis and fixed to a respective output axle; and
at least two sets of paired combination gears, each combination gear of each pair having (a) an axis of rotation that is substantially perpendicular to said output axis, and (b) a first gear portion spaced apart from a worm-wheel portion, said first gear portions of said combination gear pair being in mating engagement with each other, and said worm-wheel portions of said combination gear pair being in mating engagement, respectively, with a respective one of said side-gear worms.

14. The differential steering-drive of claim 13, wherein said all-gear limited slip differential further comprises a thrust plate maintained in a fixed position between the inner ends of said pair of side-gear worms.

15. The differential steering-drive of claim 9 further comprising a first pair of axle differentials interconnecting said respective track drive shafts with a first pair of front drive shafts and a first pair of rear drive shafts, wherein said first pair of axle differentials comprises a first pair of all-gear limited slip differentials.

16. The differential steering-drive of claim 15 further comprising a second pair of axle differentials interconnecting said respective front drive shafts or said respective rear drive shafts with a first pair of axle drive shafts and a second pair of axle drive shafts, wherein said second pair of axle differentials comprises a second pair of all-gear limited slip differentials.
